(19) United States
(12) Patent Application Publication
(10) Pub. No.: US 2023/0379355 A1
(43) Pub. Date: Nov. 23, 2023

(54) INTERNET OF THINGS SECURITY

(71) Applicant: BRITISH TELECOMMUNICATIONS PUBLIC LIMITED COMPANY, London (GB)

(72) Inventors: Xiao-Si WANG, London (GB); Christopher NUGENT, London (GB); Pushpinder CHOUHAN, London (GB); Md BISWAS, London (GB)

(21) Appl. No.: 18/247,128

(22) PCT Filed: Sep. 29, 2021
(86) PCT No.: PCT/EP2021/076741

§ 371 Date: Mar. 29, 2023

(30) Foreign Application Priority Data
Sep. 29, 2020 (GB) 2015370.6

(51) Int. Cl. H04L 9/40

(52) U.S. Cl. CPC H04L 63/1441; H04L 63/1416; G16Y 30/10

(57) ABSTRACT

A computer implemented security method for a set of internet-of-things (IoT) devices, the set of devices comprising network-connected sensors and actuators, wherein a data repository stores data about the devices, actions performable by each of the devices and one or more network attacks to which at least a subset of the devices are susceptible, the method comprising: defining, for each network attack, one or more responsive actions for the attack, each responsive action identifying one or more performable actions for performance by one or more devices to mitigate the attack; detecting a device in a compromised state, the compromised state being determined based on a threshold number of occurrences of an attack perpetrated against the device; selecting responsive actions for the perpetrated attack; and triggering the responsive actions to mitigate the perpetrated attack.

### PRIORITY CLAIM

The present application is a National Phase entry of PCT Application No. PCT/EP2021/076741, filed Sep. 29, 2021, which claims priority from GB Patent Application No. 2015370.6, filed Sep. 29, 2020, each of which is hereby fully incorporated herein by reference.

### TECHNICAL FIELD

The present disclosure relates to security of internet of things (IoT) devices.

### BACKGROUND

The Internet-of-Things (IoT) is comprised of physical objects (things) coupled with, embedded with, comprising or constituting network-connected sensors and/or actuators. Conventional objects can be supplemented by such sensors/actuators or specific IoT components can be provided as such. For example, domestic appliances, smart home technology, industrial apparatus or conceivably any object may include network connected sensors and/or actuators.

Due to the network-connected nature of IoT devices, they are susceptible to malicious action such as intrusion, modification, misappropriation, denial of service, misuse or other conceivable malicious activities. Furthermore, IoT devices include low-performance, low-resource devices lacking capabilities to detect and respond to such malicious actions.

### SUMMARY

Accordingly there is a need to address security of IoT devices.

According to a first aspect of the present disclosure, there is provided a computer implemented security method for a set of internet-of-things (IoT) devices, the set of devices comprising network-connected sensors and actuators, wherein a data repository stores data about the devices, actions performable by each of the devices and one or more network attacks to which at least a subset of the devices are susceptible, the method comprising: defining, for each network attack, one or more responsive actions for the attack, each responsive action identifying one or more performable actions for performance by one or more devices to mitigate the attack; detecting a device in a compromised state, the compromised state being determined based on a threshold number of occurrences of an attack perpetrated against the device; selecting responsive actions for the perpetrated attack; and triggering the responsive actions to mitigate the perpetrated attack.

In embodiments, multiple devices are detected in a compromised state and the method further comprising: prioritizing the multiple compromised devices based on the threshold number of occurrences for each device.

In embodiments, triggering the responsive actions includes communicating with the one or more devices for the responsive actions to trigger the performable actions identified by the responsive actions, wherein the communication is encrypted.

In embodiments, the data repository further includes the defined responsive actions.

In embodiments, selecting responsive actions includes identifying devices within a predetermined proximity of the compromised device so as to provide the mitigation of the perpetrated attack in proximity to an effect of the attack.

In embodiments, the compromised state is detected based on data received from one or more sensor devices.

In embodiments, the compromised state is detected based on network traffic communicated with the compromised device.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE FIGURES

Embodiments of the present disclosure will now be described, by way of example only, with reference to the accompanying drawings, in which:

FIG. 1 is a block diagram a computer system suitable for the operation of embodiments of the present disclosure;

FIG. 2 is component diagram of an exemplary arrangement of a security mechanism for IoT devices according to embodiments of the present disclosure;

FIG. 3 is component diagram of a further exemplary arrangement of a security mechanism for IoT devices according to embodiments of the present disclosure; and

FIG. 4 is a flowchart of a security method for IoT devices according to embodiments of the present disclosure.

### DETAILED DESCRIPTION

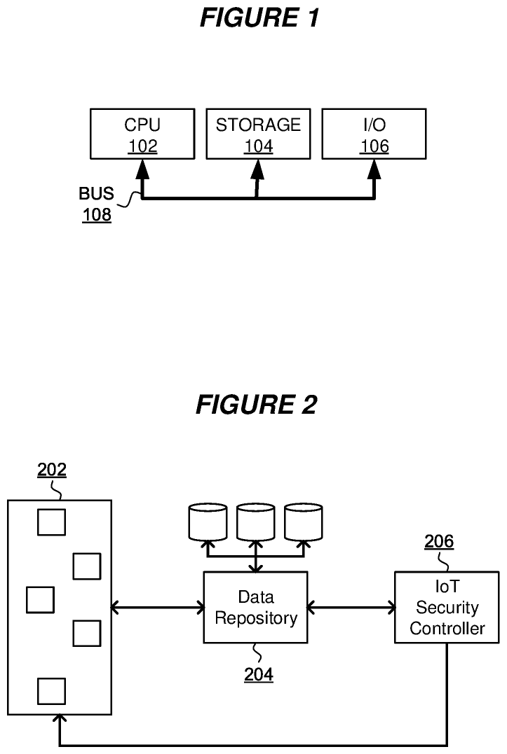

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

Embodiments of the present disclosure trigger responsive actions to mitigate an attack perpetrated against an IoT device. In particular, the responsive actions are determined based on a data repository storing data about a set of IoT devices, actions performable by the devices and attacks to which at least some of the devices are susceptible. Responsive actions are defined for each attack identifying actions to be performed by devices to mitigate an attack. For example, a sensor IoT device detecting a sound, temperature or other measurable or detectable occurrence may be determinative of an occurrence of an attack. Embodiments of the present disclosure detect such attack constituting a compromised state of the sensor or a device proximate to or in communication with the sensor. Responsive actions are determined base don the data repository and defined responsive actions to trigger the actions to mitigate the attack. The triggered actions are performed by one or more devices identified by the responsive actions that can include devices other than the device in the compromised device.

FIG. 2 is component diagram of an exemplary arrangement of a security mechanism for IoT devices according to embodiments of the present disclosure. A set of IoT devices 202 includes network connected sensors and actuators. Such IoT devices 202 can include, inter alia, by way of example only: temperature sensors; sound sensors; moisture/humidity sensors; pressure sensors; signal sensors; light sensors; time sensors; olfactory sensors; detectors such as gas detectors; cameras; movement actuators; sound emitting actuators; heaters; coolers; dispensers such as gas, liquid, article or other dispensers; network communicators; doorbells; thermostats; sprinklers; fire alarms; lights; baby monitors; message senders such as short-messaging-service transmitters; security cameras; alarms; emergency callers; webcams; network connected domestic appliances; entertainment devices; or any combinations thereof, or other devices as will be apparent to those skilled in the art. Notably, the IoT devices 202 can each be independent and not directly interoperable such as IoT devices that are not associated with each other, except that all IoT devices are network connected such as by wired or wireless connection to the internet, an intranet, or other suitable communications network.

A data repository 204 is provided in communication with the IoT devices 202 and includes one or more data stores such as databases, files or the like storing data about the IoT devices 202. Such data can include, for example, an identification of each device, a name of each device and a type of each device, such type being indicative of a nature of the device (e.g. a sensor, actuator or both) and/or its capabilities. Thus, the data repository 204 also includes data identifying any actions performable by each of the devices in which sensing and actuation are examples of actions. The data repository 204 further stores information about one or more network attacks to which at least a subset of the devices are susceptible, such as attacks by which control of a device is obtained by a malicious agent or attacks by which device data is accessible to a malicious agent. Network attack information stored in the data repository 204 is defined such that network attacks can be detected or otherwise recognized by, for example, definition of the characteristics, symptoms or effects of each attack in the data repository 204. The network attacks are so-called because they are perpetrated via a network via which a target IoT device communicates. Notably, such network can include communications by unconventional means including, for example, data transfer by light or sound.

According to embodiments of the present disclosure, one or more responsive actions for each identified network attack are defined. Such responsive actions can be stored by the data repository 204 or elsewhere (such as the controller 206 described below). Each responsive action identifies one or more performable actions for performance by one or more devices to mitigate an identified network attack. Notably, the performable actions can be performed by one or more devices other than an attacked device. For example, where a light-emitting IoT device is attacked, a responsive action can involve a sound-emitting IoT device performing an action.

An IoT security controller 206 is provided as a hardware, software, firmware or combination component in communication with the data repository 204 (such as by direct connection, link or network connection). The controller 206 is operable to identify attacks of devices 202 based on the data repository 204, so detecting devices 202 in a compromised state. The detection, by the controller 206, of a device in a compromised state is made with reference to the attack information stored in the data repository 204. Such attack information can be used to detect attacks to determine one or more devices 202 in a compromised state based on either or both of: data received from IoT devices 202 such as sensors; and network traffic communicated by, to or with IoT devices 202, such as anomalous or modified network traffic.

The controller 206 is further operable to select one or more responsive actions for the attacks based on the defined responsive actions and trigger the responsive actions to mitigate the perpetrated attack. In this way, the controller 206 is operable to detect and respond to network attacks perpetrated against IoT devices 202.

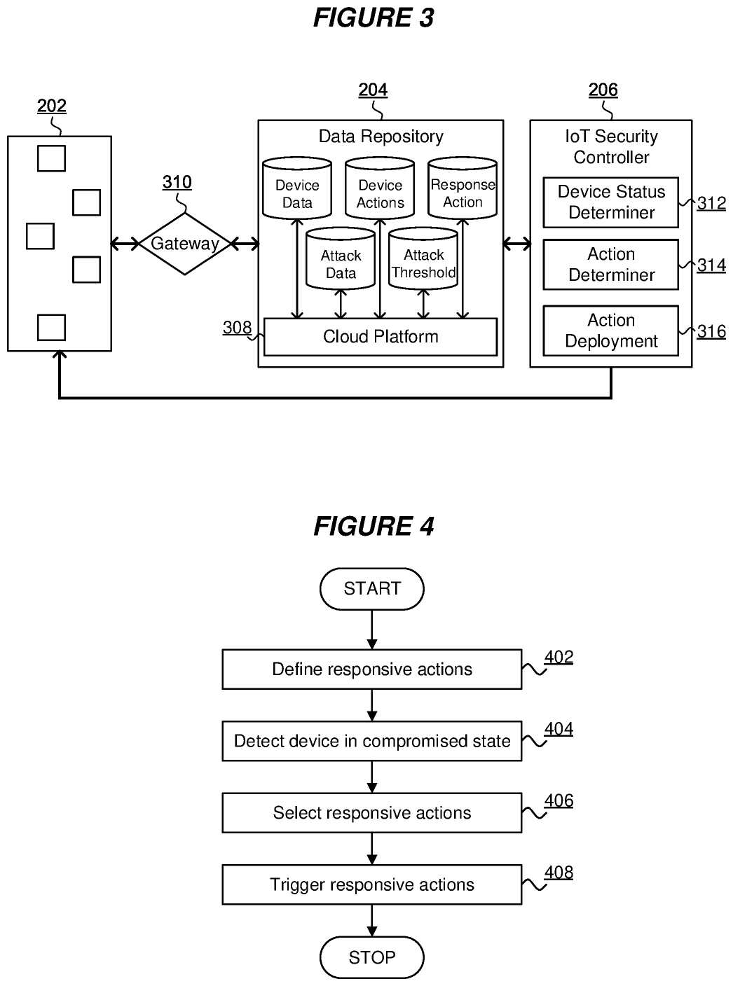

A detailed exemplary arrangement of the security mechanism will now be described with reference to FIG. 3. FIG. 3 is component diagram of a further exemplary arrangement of a security mechanism for IoT devices according to embodiments of the present disclosure. Many of the features of FIG. 3 are identical to those described above with respect to FIG. 2 and these will not be repeated here. FIG. 3 further includes an IoT gateway component 310 for managing data communication between IoT devices (that can communicate in disparate ways or using disparate protocols). Such an IoT gateway provides access to information about or from, and communication with, the IoT devices by the data repository 204 and the controller 206. In some embodiments the gateway is configured to perform processing of data received from or sent to IoT devices 202, such as for conversion to a common format, parsing to interpret data, cryptographic processing of data, normalizing of data or the like. Such IoT gateway 310 thus provides interoperability and potentially scalability between different networks, network protocols, IoT device standards and the IoT devices 202 themselves.

The data repository 204 of FIG. 3 further includes a cloud platform 308 such as one or more hosted data facilities provided by a platform as a service or software as a service mechanism and/or by a network-connected data storage and retrieval mechanism. The data repository 204 includes data stores such as databases which can be unified, separated, combined, distributed, localized or otherwise arranged as will be apparent to those skilled in the art. A “device data” data store is provided including device data such as one or more of a device identifier, name, functions, location, capabilities, version, vendor or other device information about at least a subset of the IoT devices 202. A “device actions” data store is provided including an indication, for at least a subset of the devices 202, of sensing and/or actuation actions performable by the devices. An “attack data” data store is provided including, for each of at least subset of the devices 202, an identification of a device and an identification of an attack that may be perpetrated against the device. Each attack has associated attack characteristics, criteria or other information suitable for detecting the attack. The data store 204 further includes an “attack threshold” data store identifying, for each device and each attack to which the device is susceptible, a threshold degree or extent of the attack which, when met, indicates that an attack is malicious and/or otherwise indicates that the attack is to be mitigated. For example, the threshold degree can be a number of occurrences of an attack against a device before the attack is determined to require mitigation and/or the device is determined to require protection or remedial action. The data repository 204 further includes a “response action” data store defining performable actions that are to be triggered in one or more devices 202 in response to an identified attack. Such “response action” data includes the responsive actions described earlier.

The controller 206 of FIG. 3 includes a device status determiner 312 component as a hardware, software, firmware or combination component for determining a status of an IoT device 202 and, specifically, to determine if a device 202 is in a compromised state. The device status determiner 312 uses the “attack data” data store of the data repository 204 to make such a determination. Notably, such determination is made with reference to the “attack threshold” data store such that a compromised state is determined based on a threshold number of occurrences of an attack perpetrated against the device.

The controller 206 of FIG. 3 further includes an action determiner 314 component as a hardware, software, firmware or combination component for determining one or more responsive actions to an attack detected by way of a detection of a compromised state by the device status determiner 312. The responsive actions are selected based on the “response actions” data store and, in some embodiments, the “device actions” data store and include an identification of one or more selected devices 202 and the actions such devices are to perform in response to the detected attack. Subsequently, an action deployment 316 component as a hardware, software, firmware or combination component is operable to trigger activation, execution or performance of the selected responsive actions by IoT devices 202 to mitigate the perpetrated attack.

In one embodiment, at least the triggering by the action deployment component 316 is performed by network communication to or with the IoT devices 202 where the communication is encrypted. In this way information relating to the responsive actions and their triggering is not susceptible to interception or modification by an attacker.

In one embodiment, the selectin of responsive actions by the action determiner 314 component includes identifying IoT devices 202 within a predetermined proximity of a compromised device. In this way responsive actions can be mitigated by devices 202 proximate to devices in a compromised state.

FIG. 4 is a flowchart of a security method for IoT devices according to embodiments of the present disclosure. Initially, at 402, the method defines responsive actions for each network attack, each responsive action identifying performable actions for performance by devices to mitigate the attack. At 404 the device status determiner 312 detects a device in a compromised state based on a threshold number of occurrences of an attack perpetrated against the device. At 406 the action determiner 314 selects responsive actions for the perpetrated attack and at 408 the action deployment component 316 triggers the selected responsive actions to mitigate the perpetrated attach.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented security method for a set of internet-of-things (IoT) devices, the set of IoT devices comprising network-connected sensors and network-connected actuators, wherein a data repository stores data about the set of IoT devices, actions performable by each of the IoT devices and one or more types of network attack to which at least a subset of the set of IoT devices are susceptible, the method comprising:
defining, for each type of network attack of the one or more types of network attack, one or more responsive actions for the respective type of network attack, each responsive action identifying one or more performable actions for performance by one or more IoT devices of the set of IoT devices to mitigate an attack of the respective type;
detecting an IoT device of the set of IoT devices in a compromised state, the compromised state being determined based on a threshold number of occurrences of a particular type of attack perpetrated against the IoT device of the one or more types of network attack;
selecting at least one responsive action for the perpetrated attack based on the type of the attack; and
triggering the selected at least one responsive action to mitigate the perpetrated attack.

2. The method of claim 1, wherein multiple IoT devices are detected in a compromised state, the method further comprising:
prioritizing the multiple IoT devices in the compromised state based on the threshold number of occurrences for each IoT device.

3. The method of claim 1, wherein triggering the responsive actions includes communicating with the one or more IoT devices for the responsive actions to trigger the one or more performable actions identified by the responsive actions, wherein the communicating is encrypted.

4. The method of claim 1, wherein the data repository further includes the defined one or more responsive actions.

5. The method of claim 1, wherein selecting responsive actions includes identifying IoT devices within a predetermined proximity of the compromised IoT device and using the identified proximate IoT device to provide the mitigation of the perpetrated attack.

6. The method of claim 1, wherein the compromised state is detected based on data received from one or more sensors of the network-connected sensors.

7. The method of claim 1, wherein the compromised state is detected based on network traffic communicated with the compromised IoT device.

8. A computer system comprising:
a processor and memory storing computer program code for implementing a security method for a set of internet-of-things (IoT) devices, the set of IoT devices comprising network-connected sensors and network-connected actuators, wherein a data repository stores data about the set of IoT devices, actions performable by each of the IoT devices and one or more types of network attack to which at least a subset of the set of IoT devices are susceptible, by:
defining, for each type of network attack of the one or more types of network attack, one or more responsive actions for the respective type of network attack, each responsive action identifying one or more performable actions for performance by one or more IoT devices of the set of IoT devices to mitigate an attack of the respective type;
detecting an IoT device of the set of IoT devices in a compromised state, the compromised state being determined based on a threshold number of occurrences of a particular type of attack perpetrated against the IoT device of the one or more types of network attack;
selecting at least one responsive action for the perpetrated attack based on the type of the attack; and
triggering the selected at least one responsive action to mitigate the perpetrated attack.

9. A non-transitory computer-readable storage medium storing a computer program element comprising computer program code to, when loaded into a computer system and executed thereon, cause the computer system to implement a security method for a set of internet-of-things (IoT) devices, the set of IoT devices comprising network-connected sensors and network-connected actuators, wherein a data repository stores data about the set of IoT devices, actions performable by each of the IoT devices and one or more types of network attack to which at least a subset of the set of IoT devices are susceptible, by:
defining, for each type of network attack of the one or more types of network attack, one or more responsive actions for the respective type of network attack, each responsive action identifying one or more performable actions for performance by one or more IoT devices of the set of IoT devices to mitigate an attack of the respective type;
detecting an IoT device of the set of IoT devices in a compromised state, the compromised state being determined based on a threshold number of occurrences of a particular type of attack perpetrated against the IoT device of the one or more types of network attack;
selecting at least one responsive action for the perpetrated attack based on the type of the attack; and
triggering the selected at least one responsive action to mitigate the perpetrated attack.
